(19) United States
(12) Patent Application Publication
(10) Pub. No.: US 2026/0350909 A1
(43) Pub. Date: Nov. 5, 2026

(54) STOCHASTIC RAY TRACING FOR RENDERING DIGITAL ASSETS

(71) Applicant: Adobe Inc., San Jose, CA (US)

(72) Inventors: Xin Sun, Palo Alto, CA (US); Yun Fei, Alameda, CA (US); Preetish Kakkar, Redmond, WA (US); Miloš Hašan, Lafayette, CA (US); Jonathan Andrew Eisenmann, San Francisco, CA (US); Iliyan Atanasov Georgiev, London (GB); Fujun Luan, Sunnyvale, CA (US)

(73) Assignee: Adobe Inc., San Jose, CA (US)

(21) Appl. No.: 19/194,707

(22) Filed: Apr. 30, 2025

(51) Int. Cl. G06T 15/06; G06F 7/58

(52) U.S. Cl. CPC G06T 15/06; G06F 7/588

(57) ABSTRACT

Techniques for stochastic ray tracing for rendering digital assets are described and are implementable to efficiently render digital assets within scenes. In an example, a digital asset that includes transparent three-dimensional primitives is received to be included in a scene. Candidate intersections between a ray traced from a viewpoint within the scene and one or more of the primitives are identified. An intersection is selected from the candidate intersections based on binarized opacity values and distance values to the viewpoint determined for each of the candidate intersections. The digital asset is then rendered within the scene by applying a color value associated with the selected intersection to one or more pixels.

### BACKGROUND

A variety of techniques are usable to render digital assets, such as three-dimensional models, scenes, and environments, to create realistic images. For instance, ray tracing techniques are used to simulate paths of light as they interact with objects and surfaces in a scene, which supports creation of realistic, high-fidelity images with accurate reflections, shadows, and global illumination effects. However, this process involves simulation of a large number (e.g., millions) of ray-object intersections and light interactions, and thus it is often computationally expensive to render digital assets using these techniques, particularly to render complex scenes with numerous objects and intricate lighting conditions. Accordingly, conventional ray tracing techniques are often not suitable for real-time applications such as interactive games or virtual reality and further are unable to be effectively implemented by computing devices without substantial processing power.

### SUMMARY

Techniques for stochastic ray tracing for rendering digital assets are described that support computationally efficient rendering and relighting of digital assets that include various rendering primitives, e.g., transparent three-dimensional primitives, within scenes. In an example, a processing device receives a digital asset that includes three-dimensional primitives to be included in a scene, such as transparent primitives of a Gaussian splat. The processing device identifies candidate intersections between a ray traced from a viewpoint within the scene and one or more of the three-dimensional primitives. The processing device selects an intersection from the candidate intersections based on binarized opacity values and distance values to the viewpoint determined for each of the candidate intersections. The selected intersection, for instance, is a candidate intersection that is “closest” to the viewpoint that has been stochastically determined by the processing device to be opaque.

The processing device then renders the digital asset within the scene by applying a color value associated with the selected intersection to a pixel. This process is repeatable to determine pixel colors for each pixel in an image to depict the digital asset within the scene. Accordingly, the techniques described herein efficiently approximate a color value for a pixel via informed stochastic selection of a representative intersection. In this way, these techniques reduce memory usage and computational complexity relative to conventional techniques to render three-dimensional digital assets and further maintain high visual quality and support a variety of lighting effects and operations.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The detailed description is described with reference to the accompanying figures. Entities represented in the figures are indicative of one or more entities and thus reference is made interchangeably to single or plural forms of the entities in the discussion.

FIG. 1 is an illustration of a digital medium environment in an example implementation that is operable to employ the stochastic ray tracing for rendering digital assets techniques described herein.

FIG. 2 depicts a system in an example implementation showing operation of the rendering module of FIG. 1 in greater detail.

FIG. 3 depicts an example of stochastic ray tracing for rendering of digital assets in which a color for a pixel is determined.

FIG. 4 depicts an additional example of stochastic ray tracing for rendering of digital assets in which a color for a pixel is determined.

FIG. 5 depicts an additional example of stochastic ray tracing for rendering of digital assets in which a color for a pixel is determined using multiple samples per pixel.

FIG. 6 depicts an example of stochastic ray tracing for rendering of digital assets in which images generated with varying samples per pixel values are depicted.

FIG. 7 depicts an example of an algorithm usable to perform aspects of stochastic ray tracing for rendering of digital assets.

FIG. 8 depicts an example of stochastic ray tracing for rendering of digital assets in which a viewpoint of a scene is changed.

FIG. 9 is a flow diagram depicting an algorithm as a step-by-step procedure in an example implementation that is performable by a processing device to render a digital asset using the stochastic ray tracing techniques described herein.

FIG. 10 is a flow diagram depicting an algorithm as a step-by-step procedure in an example implementation that is performable by a processing device to generate a binarized opacity value.

FIG. 11 illustrates an example system including various components of an example device that can be implemented as any type of computing device as described and/or utilized with reference to FIGS. 1-10 to implement embodiments of the techniques described herein.

### DETAILED DESCRIPTION

### Overview

Conventional techniques for rendering digital assets, such as to visually depict three-dimensional objects, scenes, and environments, often rely on ray tracing to simulate paths of light as they interact with objects and surfaces in a scene. For instance, using a conventional ray tracing approach, a final pixel color is determined by tracing rays through a scene and accumulating color contributions from various intersections and light interactions as the rays reflect, refract, scatter, are absorbed, etc. within the scene. While this approach supports creation of high-fidelity images with accurate light properties, these techniques are reliant on simulation of a large number (e.g., millions) of ray-object intersections and light interactions.

Accordingly, traditional ray tracing approaches require extensive processing to sort each of the intersections along each ray to determine a color value for a single pixel. This is computationally expensive and memory-intensive, particularly to render complex scenes or digital assets that are defined by millions of primitives. Thus, implementation of such techniques is limited to specialized processing devices with sufficient processing power. Further, due to high rendering times, conventional path tracing approaches are often not suitable for real-time applications such as interactive games or virtual reality/augmented reality, particularly with scenes that include digital objects with complex geometries.

Accordingly, techniques for stochastic ray tracing for rendering digital assets are described that overcome conventional limitations. The techniques described herein, for instance, support computationally efficient rendering of digital assets that include various rendering primitives, e.g., transparent three-dimensional primitives, within complex scenes. For instance, the techniques described herein stochastically select a single representative intersection based on opacity probabilities, thus obviating the conventional requirement to sort and process multiple intersections to render digital assets while maintaining a high visual quality of output images.

Consider an example in which a user of a processing device is designing an environment that includes a complex scene with objects with variable transparency, such as a futuristic cityscape with various vehicles, buildings, structures, light sources, etc. The user wishes to render this environment to support an interactive user experience, e.g., to support traversibility of the scene, while maintaining high visual quality and accurate lighting effects. In a conventional scenario, rendering such a scene with traditional ray tracing techniques would require significant computational resources and time, making it impractical for real-time dynamic applications, particularly on devices with limited or standard processing power.

To overcome these limitations, a processing device receives a digital asset that includes three-dimensional transparent rendering primitives to be included in the scene. For instance, the digital asset represents a three-dimensional model of a futuristic car that the user desires to incorporate into the futuristic scene. The model of the car is defined by multiple (e.g., hundreds of thousands, millions, etc.) rendering primitives, such as Gaussian splats that are defined by various properties that contribute to a final appearance of the car, such as depth values, opacity values, color values, etc.

To integrate the car within the scene with accurate lighting conditions, the processing device identifies candidate intersections between a ray traced from a viewpoint within the scene and one or more of the rendering primitives. In various embodiments, the processing device traverses an acceleration structure associated with the digital asset, such as a bounding volume hierarchy, to identify the candidate intersections. The candidate intersections, for instance, represent each intersection of the ray with the rendering primitives within the scene as the ray is scattered, reflected, refracted, absorbed, etc. within the scene.

The processing device then selects an intersection from the candidate intersections based on binarized opacity values and depth values, e.g., distances to the viewpoint, determined for each of the candidate intersections. For instance, each candidate intersection corresponds to a rendering primitive that is associated with a depth value, an opacity value, and a color value. The processing device stochastically determines whether to treat each candidate intersection as opaque or transparent by comparing randomly generated stochastic values to the known opacity values associated with each candidate intersection.

For instance, if the stochastic value for a particular candidate intersection is less than the opacity value, the particular candidate intersection is treated as fully opaque. If the stochastic value is greater than or equal to the opacity value, the particular candidate intersection is treated as fully transparent. Thus, each of the candidate intersections are assigned a binary opacity value that classifies the candidate intersections as opaque or transparent and further are associated with a depth value that indicates a distance to the viewpoint.

The processing device then identifies the “closest” candidate intersection to the viewpoint (e.g., a candidate intersection that has the lowest distance value of the candidate intersections) that has been stochastically determined by the processing device to be opaque. The processing device then applies a color value associated with the selected intersection to a pixel. Because the selected intersection is classified as fully opaque, the processing device disregards color contributions from subsequent intersections (e.g., intersections with a greater distance value) as the selected opaque intersection “blocks” light from reaching the subsequent intersections. Further, the processing device disregards color contributions from intersections preceding the selected intersection because the preceding intersections have been classified as fully transparent and thus do not impact shading of the pixel.

This process is repeatable to determine pixel colors for each pixel in an image to depict the digital asset within the scene. Further, in some examples the processing device iterates this process for each ray to select multiple intersections with multiple color values and determines a final pixel color as an average of the multiple color values. In this way, the techniques described herein further reduce noise and increase visual acuity.

In the context of the above example, the processing device implements the techniques described herein to efficiently render the futuristic car within the futuristic cityscape scene in accordance with lighting properties of the scene. For instance, the car is depicted with realistic shading, reflections, shadows, and so forth based on properties of the scene. Further, the processing device is able to implement the process described above to render the car within the scene under various changed conditions, such as to update an appearance of the car in real-time as the user navigates through the scene, maintaining consistent lighting and reflection properties from various angles and distances.

In this way, the techniques described herein overcome the limitations of conventional techniques by efficiently approximating color values for pixels via informed stochastic selection of representative intersections, rather than calculation of color contributions of each intersection for a particular ray. Thus, this approach reduces memory usage and computational complexity relative to conventional techniques to render three-dimensional digital assets, while maintaining high visual quality and supporting advanced lighting effects and operations. As a result, the techniques described herein support real-time rendering of complex scenes with transparent primitives on a wide range of devices, including those with standard or limited processing power, thus expanding possibilities for interactive applications and immersive experiences.

In the following discussion, an example environment is described that employs the techniques described herein. Example procedures are also described that are performable in the example environment as well as other environments. Consequently, performance of the example procedures is not limited to the example environment and the example environment is not limited to performance of the example procedures.

### Example Environment

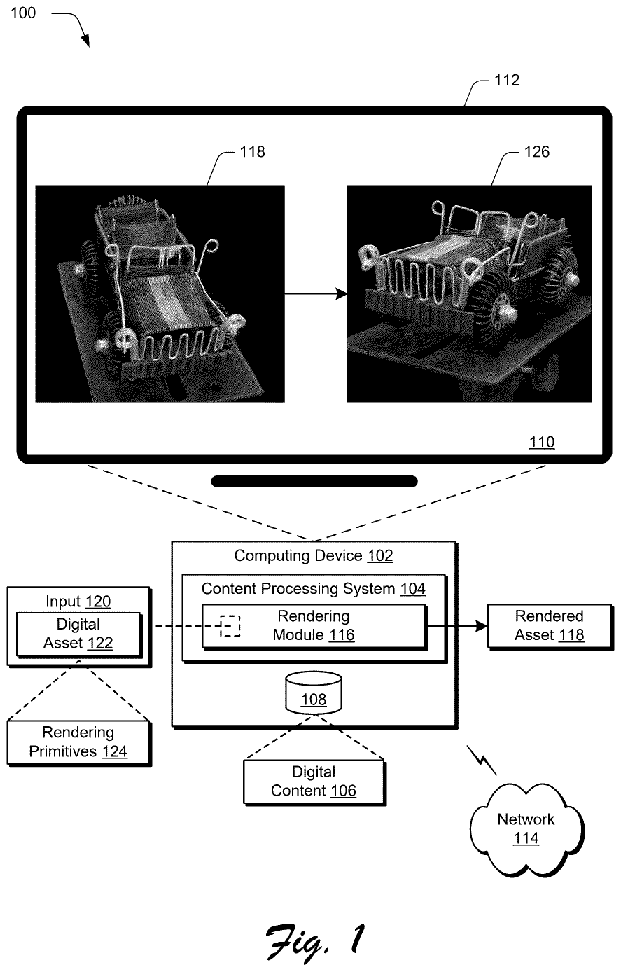

FIG. 1 is an illustration of a digital medium environment 100 in an example implementation that is operable to employ the stochastic ray tracing for rendering digital assets techniques described herein. The illustrated environment 100 includes a computing device 102, which is configurable in a variety of ways.

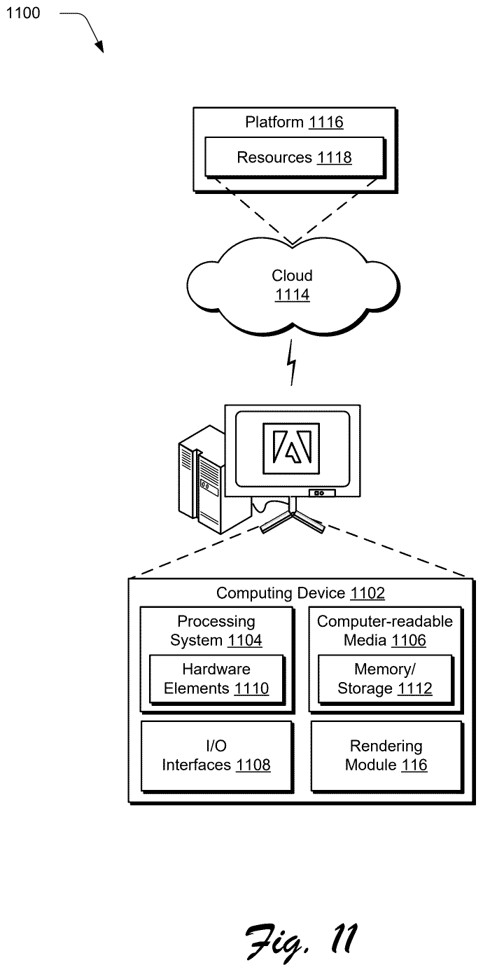

The computing device 102, for instance, is configurable as a processing device such as a desktop computer, a laptop computer, a mobile device (e.g., assuming a handheld configuration such as a tablet or mobile phone as illustrated), and so forth. Thus, the computing device 102 ranges from full resource devices with substantial memory and processor resources (e.g., personal computers, game consoles) to a low-resource device with limited memory and/or processing resources (e.g., mobile devices). Additionally, although a single computing device 102 is shown, the computing device 102 is also representative of a plurality of different devices, such as multiple servers utilized by a business to perform operations “over the cloud” as described in FIG. 11.

The computing device 102 is illustrated as including a content processing system 104. The content processing system 104 is implemented at least partially in hardware of the computing device 102 to process and transform digital content 106, which is illustrated as maintained in storage 108 of the computing device 102. Such processing includes creation of the digital content 106, modification of the digital content 106, and rendering of the digital content 106 in a user interface 110 for output, e.g., by a display device 112. Although illustrated as implemented locally at the computing device 102, functionality of the content processing system 104 is also configurable in whole or in part via functionality available via the network 114, such as part of a web service or “in the cloud.

An example of functionality incorporated by the content processing system 104 to process the digital content 106 is illustrated as a rendering module 116. The rendering module 116 is configured to generate a rendered asset 118 for display by the display device 112, such as based on an input 120 that includes a digital asset 122. For instance, the rendering module 116 receives the input 120 that includes a digital asset 122 to be included, e.g., visually depicted, within a scene.

In some examples, the digital asset 122 includes one or more three-dimensional models (e.g., of objects, scenes, environments, etc.) to be rendered within a virtual space. The digital asset 122, for instance, includes various data, instructions, and/or mathematical representations that define a three-dimensional object, scene, or environment in a virtual space. Thus, in various implementations the digital asset 122 includes information about geometry, topology, material properties, spatial relationships, and so forth of various elements within the virtual representation.

The digital asset 122 includes rendering primitives 124 that define various characteristics of the digital asset 122. The rendering primitives 124, for instance, have varying opacity, and as such include transparent, semi-transparent, and/or opaque rendering primitives 124. In various examples, the rendering primitives 124 are three-dimensional and as such define aspects of a three-dimensional structure of the digital asset 122. The rendering primitives 124 are further able to describe various other properties of the digital asset 122, such as color, texture, reflectivity, material properties, and so forth.

In various embodiments, the rendering primitives 124 include one or more Gaussian splats. Gaussian splat primitives, for instance, are defined by one or more of a mean position, a covariance matrix that determines shape and orientation, and/or attributes such as color and opacity values. These rendering primitives 124 are usable to represent complex geometries and visual effects. In various examples, a single digital asset 122 includes hundreds of thousands to millions of transparent, anisotropic three-dimensional Gaussian rendering primitives 124 with view-dependent colors and/or shading properties.

This is by way of example and not limitation, and in some examples the rendering primitives 124 include one or more, polygons, voxels, point clouds, implicit surfaces, parametric curves and surfaces, and/or other geometric elements that define visual characteristics and/or a structure of the digital asset 122. In at least one example, the rendering primitives 124 includes two-dimensional primitives that are associated with a depth value, e.g., depth defined two-dimensional discs. Thus, the techniques described herein are able to be integrated into a variety of rendering pipelines.

As further described in more detail below, the rendering module 116 is operable to generate the rendered asset 118 in a computationally efficient manner, such as by implementing the stochastic ray tracing techniques described herein. For instance, the rendering module 116 is implementable to stochastically select representative intersections between traced light rays and the rendering primitives 124 based on opacity probabilities and shade/relight the rendered asset 118 based on the representative intersections. In this way, the rendering module 116 efficiently approximates color values for pixels without the conventional computational burden of color contribution calculation for each intersection along each light ray. As a result, the rendering module 116 supports production of high-quality rendered assets 118 with reduced computational complexity compared to conventional ray tracing techniques.

For instance, as depicted in the illustrated example, a computing device 102 receives an input 120 that includes a digital asset 122. In this example, the digital asset 122 is a representation of a model car and includes various rendering primitives 124, e.g., transparent three-dimensional Gaussian primitives, that define various properties of the model car. Using the stochastic ray tracing techniques described herein, the rendering module 116 generates the rendered asset 118 within a scene, which is output for display in the user interface 110 of the display device 112 as illustrated.

In this example, the rendering module 116 further receives an additional input to change a condition of the scene that includes the rendered asset 118. For instance, a user provides an input to edit a camera view of the digital asset 122, such as to reposition a virtual camera to view the model car “head on.” The rendering module 116 implements the stochastic ray tracing techniques to render the edited asset 126 in real time with updated visual properties in accordance with the changed condition of the scene. Thus, the techniques described herein support an interactive experience for creation and modification of complex three-dimensional scenes, which is not possible in real-time by devices with standard and/or limited GPU resources using conventional techniques. Further discussion of these and other advantages is included in the following sections and shown in corresponding figures.

In general, functionality, features, and concepts described in relation to the examples above and below are employed in the context of the example procedures described in this section. Further, functionality, features, and concepts described in relation to different figures and examples in this document are interchangeable among one another and are not limited to implementation in the context of a particular figure or procedure. Moreover, blocks associated with different representative procedures and corresponding figures herein are applicable together and/or combinable in different ways. Thus, individual functionality, features, and concepts described in relation to different example environments, devices, components, figures, and procedures herein are usable in any suitable combinations and are not limited to the particular combinations represented by the enumerated examples in this description.

### Stochastic Ray Tracing for Rendering Digital Assets

The following discussion describes techniques that are implementable utilizing the previously described systems and devices. Aspects of each of the procedures are implemented in hardware, firmware, software, or a combination thereof. The procedures are shown as a set of blocks that specify operations performed by one or more devices and are not necessarily limited to the orders shown for performing the operations by the respective blocks. Blocks of the procedures, for instance, specify operations programmable by hardware (e.g., processor, microprocessor, controller, firmware) as instructions thereby creating a special purpose machine for carrying out an algorithm as illustrated by the flow diagram. As a result, the instructions are storable on a computer-readable storage medium that causes the hardware to perform the algorithm. In portions of the following discussion, reference will be made to FIGS. 1-10.

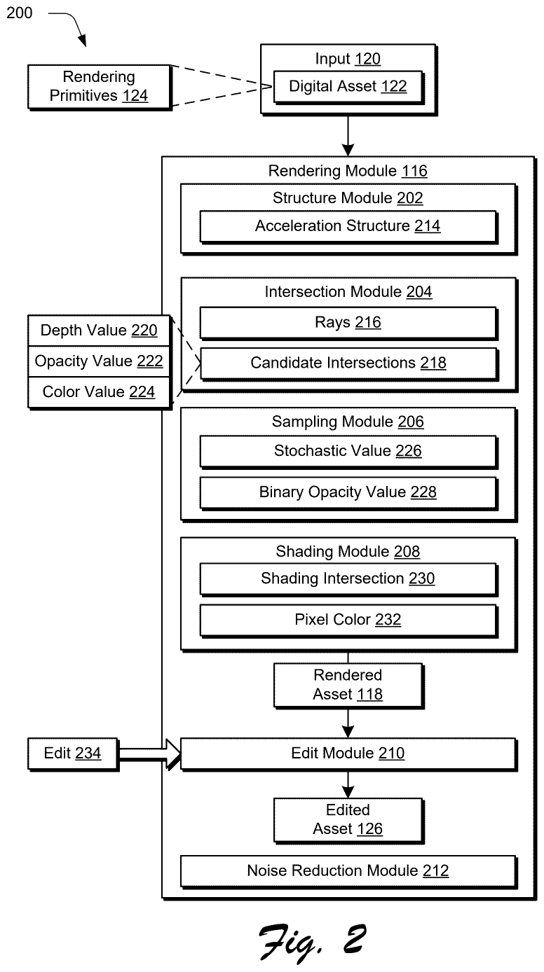

FIG. 2 depicts a system 200 in an example implementation showing operation of the rendering module 116 of FIG. 1 in greater detail. Generally, the rendering module 116 is configured to generate a rendered asset 118 within a scene using a stochastic ray tracing approach. The rendering module 116 is further operable to generate an edited asset 126, such as based on various inputs to change conditions of the scene. In this example, the rendering module 116 includes a structure module 202, an intersection module 204, a sampling module 206, a shading module 208, an edit module 210, and a noise reduction module 212 that interact with one another to perform the operations described herein.

### Digital Asset Processing and Intersection Determination

For example, the rendering module 116 receives an input 120 that includes a digital asset 122 to be included in a scene. As described above, the digital asset 122 is defined by one or more rendering primitives 124. For instance, the digital asset 122 is a Gaussian asset and the rendering primitives 124 include various transparent three-dimensional Gaussian splats that define one or more objects, elements, structures, etc. to be rendered within the scene. The rendering primitives 124 are further associated with values that define visual properties of the digital asset 122 under variable conditions, and thus support relighting and visualization within a variety of scenes.

To do so, the structure module 202 first generates an acceleration structure 214 that organizes the rendering primitives 124. In various implementations, the acceleration structure 214 is a bounding volume hierarchy (“BVH”) that supports traversal to identify intersections between traced light rays, e.g., rays 216, and the rendering primitives 124. In an example, the intersection module 204 constructs the BVH by generating axis-aligned bounding boxes (“AABB's”) that encapsulate individual rendering primitives 124.

For each rendering primitive 124, (e.g., a Gaussian splat), an AABB is computed to approximate a spatial extent of the respective rendering primitives 124. For instance, the spatial extent extends to a predetermined standard deviation beyond which the rendering primitives 124 is considered negligible. The structure module 202 further hierarchically groups individual AABBs into larger bounding volumes, such as to form a tree structure with a single root node that encompasses the digital asset 122. This hierarchical organization of the acceleration structure 214 allows rays 216 to be tested against progressively smaller volumes and supports efficient pruning of portions of the scene and/or rendering primitives 124 that are outside the spatial extent and do not intersect with a ray 216, thus reducing the computational complexity of intersection testing.

For instance, the intersection module 204 processes rays 216 traced from a viewpoint within the scene and determines candidate intersections 218 between the rays 216 and the rendering primitives 124. For instance, as a particular ray 216 interacts with various rendering primitives 124 by reflecting, refracting, scattering, or being absorbed as it propagates through the scene, and thus intersects with multiple rendering primitives 124. Accordingly, in various examples the rays 216 are associated with multiple candidate intersections 218, e.g., dozens, hundreds, thousands, etc.

In an example in which the acceleration structure 214 includes a BVH, the intersection module 204 traverses the acceleration structure 214 and returns the candidate intersections 218 in an unsorted and/or semi-sorted “BVH order,” e.g., the candidate intersections 218 are not necessarily sorted by depth from the viewpoint. Conventional ray tracing approaches are reliant on sorting these intersections by depth to correctly calculate color contributions, which is computationally expensive and memory-intensive, particularly for scenes with thousands of intersections per ray. However, the approach described herein obviates the conventional demand to sort the candidate intersections 218 and instead shades pixels based on a closest opaque intersection as further described below. This significantly reduces computational complexity and memory usage, allowing the system 200 to efficiently render digital assets 122 within scenes on devices without advanced processing capabilities.

The intersection module 204 further determines properties associated with each of the candidate intersections 218, such as a depth value 220, an opacity value 222, and a color value 224. These properties, for instance, are obtained by the intersection module 204 based on the respective rendering primitive 124 associated with each candidate intersection 218. A depth value 220, for instance, represents a distance from the viewpoint to a candidate intersection 218 along a ray 216. In various implementations, a depth value 220 is the mean of a 1D Gaussian along the ray 216 and/or is based on a projected center of the rendering primitive 124. As further described below, the depth value 220 is used to determine which candidate intersection 218 is closest to the viewpoint when multiple opaque intersections are identified.

An opacity value 222, for instance, is a non-binary value that represents a degree of transparency of a rendering primitive 124 at a candidate intersection 218. For example, the opacity value has a range of zero (e.g., fully transparent) to one, e.g., fully opaque. Accordingly, non-binarized opacity values 222 that fall between zero and one indicate that a rendering primitive 124 is semi-transparent/semi-opaque and thus transmits a portion of light and blocks a portion of light. As further described in more detail below, the opacity value 222 is usable to determine whether a candidate intersection 218 is treated as opaque or transparent during an opacity binarization process. For example, a rendering primitive 124 with an opacity value 222 of 0.8 has an 80% probability of being treated as fully opaque and a 20% probability of being treated as fully transparent.

A color value 224, for instance, represents visual appearance information associated with a candidate intersection 218, such as RGB values, HSV values, or other color space representations. In some examples, the color value 224 includes view-dependent colors, material properties, lighting effects, and/or other visual characteristics that determine how portions of the rendering primitive 124 appear when rendered under varying conditions. In one example, a color value 224 is represented as (R:255, G:0, B:0) for a red appearance or (R:0, G:255, B:0) for a green appearance. In one or more implementations, a color value 224 is representative of a result of evaluation of the rendering primitive 124 (e.g., a Gaussian primitive) at a shading position defined by a corresponding depth value 220, such as evaluation of a light transport associated with the Gaussian primitive at the shading position.

The rendering module 116 thus efficiently organizes and processes the rendering primitives 124 and is further operable to determine various properties of the candidate intersections 218 usable in the stochastic sampling and shading processes described in the following discussion.

### Stochastic Shading Value Determination

Using conventional ray-tracing techniques, each ray intersection is sorted by depth and individually evaluated for color contribution, which requires significant GPU processing resources. However, the techniques described herein circumvent this step by shading a pixel based on a probabilistically determined reduced number of candidate intersections 218 and thereby conserve processing resources relative to conventional approaches.

For instance, the rendering module 116 includes a sampling module 206 that is operable to generate a stochastic value 226 for each of the candidate intersections 218 and further generate a binary opacity value 228 for each of the candidate intersections 218 based on the stochastic values 226 and opacity values 222. The rendering module 116 also includes a shading module 208 that is operable to select one or more of the candidate intersections 218 based on the binary opacity values 228 and the depth values 220. The selected candidate intersections 218, e.g., one or more shading intersections 230, are then used by the shading module 208 to determine pixel colors 232 to generate the rendered asset 118.

For instance, each ray 216 that is traced from the viewpoint corresponds to a pixel. The shading module 208 identifies at least one shading intersection 230 for each ray 216 that is usable to determine pixel colors 232 of the corresponding pixel based on the binary opacity values 226 and the stochastic values 226.

In an example to do so, consider a particular ray 216 that is traced from the viewpoint, through a particular pixel, and into the scene. The intersection module 204 identifies a set of candidate intersections 218 between the particular ray 216 and the rendering primitives 124. The sampling module 206 is operable to determine an opacity value 222 (e.g., a non-binarized value between zero and one) associated with each of the candidate intersections 218 in the set. In some examples, this includes evaluation of a rendering primitive 124 that corresponds to a particular candidate intersection 218.

The sampling module 206 is further operable to generate a stochastic value 226 for each of the candidate intersections 218 in the set. The stochastic value 226, for instance, is a random number with a value within a range of potential opacity values 222. For instance, where the opacity values 222 have a range of zero to one, the stochastic value 226 is likewise between zero and one. In various implementations, the sampling module 206 leverages one or more suitable random number generators and/or random number generation techniques/processes to generate the stochastic value 226.

Based on the determined opacity values 222 and the stochastic values 226, The sampling module 206 is further operable to generate a binary opacity value 228 for each candidate intersection 218 in the set. For instance, the sampling module 206 compares the stochastic value 226 for a particular candidate intersection 218 to the opacity value 222 for the particular candidate intersection 218. In an example in which the stochastic value 226 is less than a threshold, e.g., less than the opacity value 222, the binary opacity value 228 is set to one, which indicates the particular candidate intersection 218 is fully opaque. In an example in which the stochastic value 226 is greater than or equal to the threshold, e.g., greater than or equal to the opacity value 222, the binary opacity value 228 is set to zero, which indicates the particular candidate intersection 218 is fully transparent.

Thus, the opacity values 222 serve as a weighting that influences the stochastic determination in accordance with known visual properties of the digital asset 122 within the scene. For instance, a candidate intersection 218 with a relatively high opacity value 222 has a greater probability of being treated as fully opaque. Similarly, a candidate intersection 218 with a relatively low opacity value 222 has a greater probability of being treated as fully transparent which aligns with nascent visual properties of the digital asset 122.

In this way, the sampling module 206 is operable to probabilistically determine, for each candidate intersection 218 in the set, whether a candidate intersection 218 is either fully opaque or fully transparent based on its associated opacity value 222 and stochastic value 226. This opacity informed stochastic determination allows the system 200 to efficiently approximate overall visual effects of the digital asset 122 within the scene without processing each candidate intersection 218 in depth order. Thus, these techniques reduce computational complexity while preserving visual integrity of the rendered asset 118 by processing a subset of candidate intersections 218 most likely to contribute to the final pixel color 232.

For instance, the shading module 208 determines a shading intersection 230 from the candidate intersections 218 based on the binary opacity values 226 and depth values 220. Continuing with the above example, the shading intersection 230 represents a “closest opaque” candidate intersection 218 from the set of candidate intersections 218. For instance, the shading intersection 230 has a lowest depth value 220 of the candidate intersections 218 with a binary opacity value 228 of one.

In one or more examples, the shading module 208 processes the candidate intersections 218 in an order that the set is output by the intersection module 204, such as a semi-sorted “BVH” order. For instance, the candidate intersections 218 are “loosely” sorted by depth within the set, however, are not fully sorted. The shading module 208 evaluates each candidate intersection 218 and its corresponding binary opacity value 228. If the binary opacity value 228 for a particular candidate intersection 218 is zero (which indicates transparency), the shading module 208 disregards the particular candidate intersection 218 and proceeds to a subsequent candidate intersection 218 within the set.

The shading module 208 continues until a particular candidate intersection 218 with a binary opacity value 228 of one (indicating opacity) is encountered. The shading module 208 then selects this particular candidate intersection 218 as the shading intersection 230. The shading module 208 continues to process the remaining candidate intersections 218 within the set to determine if an additional candidate intersection 218 is opaque and is closer to the viewpoint than the shading intersection 230, e.g., has a relatively smaller depth value 220. If so, the shading module 208 is operable to replace the shading intersection 230 with the additional candidate intersections 218.

In some examples, the shading module 208 is operable to discontinue processing of remaining candidate intersections 218 that have a depth value 220 greater than the depth value 220 associated with the current shading intersection 230. In this way, the shading module 208 further conserves computational resources and reduces memory usage by preventing the system 200 from processing and/or storing information about subsequent candidate intersections 218 that would be occluded by the shading intersection 230. This is by way of example and not limitation, and a variety of orders and schemas to process the candidate intersections 218 are considered.

The shading module 208 then determines a pixel color 232 to apply to a pixel based on the shading intersection 230. For instance, the shading module 208 determines the pixel color 232 as a color value 224 associated with the shading intersection 230. In at least one example, the shading module 208 determines the pixel color 232 by evaluating the rendering primitive 124 associated with the shading intersection 230 at the shading intersection 230.

In one or more examples, the shading module 208 accesses color information stored by the associated rendering primitive 124, such as RGB values and/or additional or alternative color space representations. The shading module 208 is further operable to adjust the pixel color 232, such as based on properties of the digital asset 122, lighting conditions within the scene, and/or additional environmental factors. For example, the shading module 208 is operable to calculate how light sources interact with surface properties of the rendering primitive 124 at the shading intersection 230 and adjust the pixel color 232 accordingly.

In an example in which the rendering primitives 124 include Gaussian primitives, the shading module 208 is operable to evaluate a light transport of a Gaussian primitive at the shading intersection 230 to determine the pixel color 232. For instance, the shading module 208 calculates the color value 224 and/or the pixel color 232 based on surface properties of the Gaussian primitive, opacity and/or color attributes of the Gaussian primitive at the shading intersection 230, a direction of incoming light rays, a viewing angle from a virtual camera, material properties associated with the Gaussian primitive (e.g., reflectivity, specularity, roughness, etc.), shadows cast by other objects in the scene, light scattering or subsurface effects within the Gaussian primitive, and so forth. In some implementations, the shading module 208 traces additional rays from the shading intersection 230 to calculate secondary lighting effects such as shadows, reflections, or global illumination contributions that influence the final pixel color 232. As described in more detail below, in some examples the rendering module 116 traces multiple rays 216 per pixel and averages the resulting pixel colors 232 to reduce noise and improve visual quality of the final output.

Through iteration of this process, the shading module 208 generates the rendered asset 118. For instance, the rendering module 116 leverages the structure module 202, intersection module 204, sampling module 206, and shading module 208 to process multiple rays 216 traced through the scene, with each ray 216 corresponding to a pixel in a final rendered image, e.g., in the rendered asset 118. For each ray 216, the rendering module 116 implements the techniques described herein to identify candidate intersections 218, determine binary opacity values 228, select a shading intersection 230, and compute a pixel color 232. The rendering module 116 is configured to perform this process for each pixel in the image, with a collection of determined pixel colors 232 forming the rendered asset 118. Thus, the rendered asset 118 depicts the digital asset 122 integrated within the scene with realistic lighting, color, reflections, and shadows based on the lighting conditions of the scene.

The techniques described herein further support editing and/or relighting operations, such as to apply various changes to the scene and/or the rendered asset 118 and generate an edited asset 126 that retains a realistic visual appearance in accordance with lighting conditions of the scene. For instance, the rendering module 116 includes an edit module 210 that receives an edit 234 to change a condition of the scene. The edit 234 includes adjustments such as modifying a viewpoint, changing lighting conditions, adding/removing elements or assets from the scene, applying changes to the rendered asset 118, and so forth.

The edit module 210 is operable to render the edited asset 126 within the scene with the changed condition by implementing the stochastic ray tracing techniques described above. Consider an example in which a virtual camera angle is adjusted to view the rendered asset 118 from a different perspective. The edit module 210 processes the updated viewpoint, traces rays from the updated viewpoint, identifies additional candidate intersections 218, and determines updated pixel colors 232 based on updated shading intersections 230, e.g., closest opaque candidate intersections 218 from the updated viewpoint. In this way, the techniques described herein enable real-time visualization of the digital asset 122 from multiple perspectives while maintaining consistent lighting and material properties.

In an additional or alternative example, the edit 234 includes a change to a lighting condition of the scene, such as adjusting an intensity, color, or position of a light source within the scene. The edit module 210 is operable to generate the edited asset 126 by determining updated pixel colors 232 based on the changed lighting condition. For instance, the shading module 208 evaluates a light transport associated with the rendering primitives 124 at each shading intersection 230, considering the updated lighting parameters. For instance, the edit module 210 adjusts the color values 224 associated with the shading intersections 230 to reflect changes in direct illumination, shadows, indirect lighting effects and so forth. Thus, the techniques described herein support computationally efficient relighting and editing operations while maintaining visual fidelity and realism.

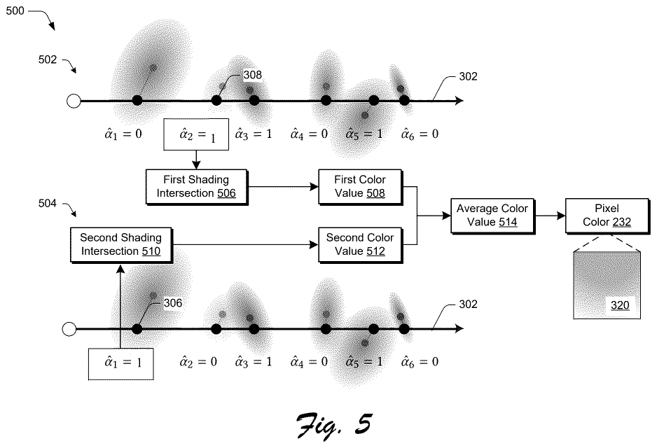

In various examples, the rendering module 116 further includes a noise reduction module 212 that is operable to implement various techniques to enhance quality of the rendered asset 118. For instance, the noise reduction module 212 is configured to control a number of samples per pixel (SPP) to reduce noise artifacts. For instance, the noise reduction module 212 causes the sampling module 206 and the shading module 208 to perform multiple passes for a ray 216, such as to identify different shading intersections 230 in each iteration. The shading module 208 is then able to average the resulting pixel colors 232 from across the multiple passes. Thus, the noise reduction module 212 is operable to implement multiple samples within a single ray traversal to efficiently improve visual quality while maintaining computational performance. This is discussed below in more detail with respect to the example shown in FIG. 5.

A variety of other noise reduction strategies that are implementable by the noise reduction module 212 are considered. In one or more examples, two or more intersections from the candidate intersections 218 are selected for each ray 216 (e.g., in a single pass) and an average color value between color values associated with the two or more selected intersections. In an additional or alternative example, the noise reduction module 212 leverages spatial and/or temporal filtering techniques to further refine the rendered output and reduce visual artifacts.

In various examples, the system 200 and/or the rendering module 116 are integrated into one or more rendering frameworks. For instance, the techniques described herein support processing of three-dimensional primitives, such as Gaussian splats, within a Monte Carlo path tracing framework. This integration enables rendering of Gaussian splats alongside traditional mesh-based assets with consistent global illumination effects.

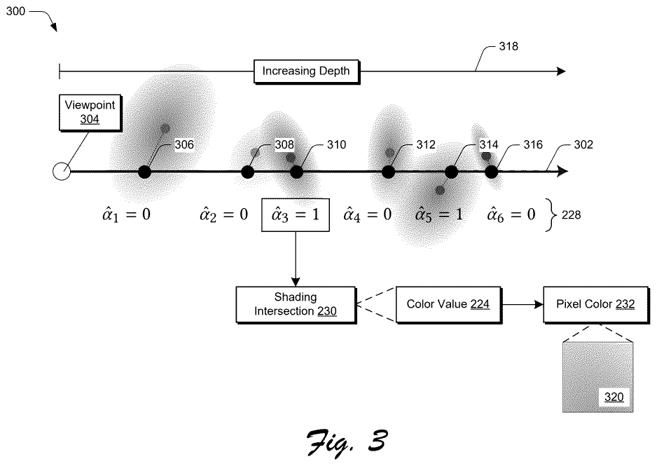

FIG. 3 depicts an example 300 of stochastic ray tracing for rendering of digital assets in which a color for a pixel is determined. The example 300, for instance, depicts a traced ray 302 that originates from a viewpoint 304 and intersects with six rendering primitives 124, which in this example are three-dimensional transparent Gaussian splat primitives.

In accordance with the techniques described herein, the rendering module 116 generates a candidate intersection 218 for each rendering primitives 124 that the traced ray 302 encounters as it propagates throughout a scene, such as a first intersection 306, a second intersection 308, a third intersection 310, a fourth intersection 312, a fifth intersection 314, and a sixth intersection 316. Each of the intersections is associated with a depth value 220, an opacity value 222, and a color value 224 based on the three-dimensional Gaussian splats that define the rendering primitives 124 in the scene. A depth axis 318 indicates a relative depth of each intersection. For instance, the depth axis 318 indicates the sixth intersection 316 is further from the viewpoint 304 along a path or the ray 302 than the first intersection 306.

For each candidate intersection 218, the rendering module 116 generates a binary opacity value 228, denoted in this example as \hat{α}ᵢ, such as based on the opacity values 222 and stochastic values 226 associated with each respective intersection. In this example, the binary opacity values 228 are definable as:

$${\hat{α}}_{i} = \{ \begin{matrix}1 , & with probability {α}_{i} \\ 0 , & with probability 1 - {α}_{i}\end{matrix} where {\hat{α}}_{i} ∈ \{ 0 , 1 \} and E [ {\hat{α}}_{i} ] = {α}_{i}$$

As illustrated, the first intersection 306, second intersection 308, fourth intersection 312, and sixth intersection 316 are assigned a binary opacity value 228 of zero, which indicates these intersections are treated as fully transparent for the purposes of rendering. The third intersection 310 and the fifth intersection 314 are assigned a binary opacity value 228 of one, which indicates these intersections are treated as fully opaque for rendering purposes.

The rendering module 116 selects the third intersection 310 as the shading intersection 230, such as based on the depth value 220 and the binary opacity value 228. For instance, of the intersections with a binary opacity value 228 of one, the third intersection 310 has the lowest depth value 220. That is, the third intersection 310 is the closest opaque intersection to the viewpoint 304.

Accordingly, the rendering module 116 determines a color value 224 associated with the shading intersection 230 under the conditions applied to the digital asset 122. The rendering module 116 then assigns the color value 224 as the pixel color 232 and applies the pixel color 232 to a pixel 320. As illustrated, the pixel 320 is rendered with a green color of the third Gaussian primitive. The rendering module 116 is further able to repeat this process to render each pixel of an image that depicts the digital asset 122 within the scene. In one or more examples, the shading (e.g., the color value 224) is representable as:

$$\hat{L} = {\sum }_{i = 1} {\hat{T}}_{i} {\hat{α}}_{i} {c}_{i} , where {\hat{T}}_{i} = {\prod }_{j = 1}^{i - 1} ( 1 - {\hat{α}}_{j} )$$

When candidate intersections with greater depth values 220 are excluded, the shading is further reducible to:

$$\hat{L} = {c}_{i} , where \{ \begin{matrix}{\hat{α}}_{j} = 0 , ∀ j such that {t}_{j} < {t}_{i} , \\ {\hat{α}}_{i} = 1.\end{matrix}$$

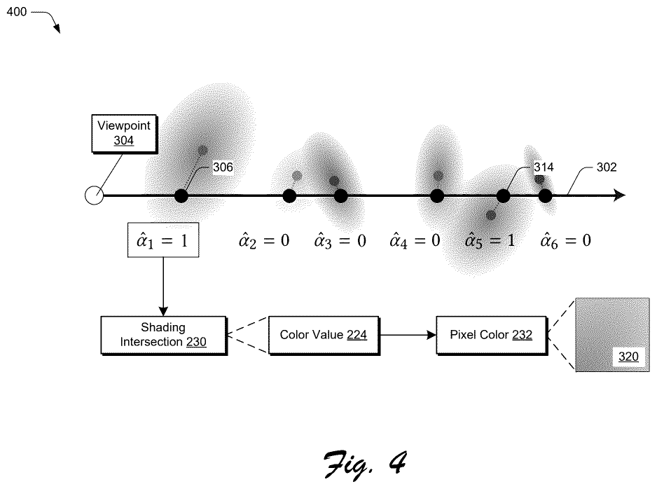

FIG. 4 depicts an additional example 400 of stochastic ray tracing for rendering of digital assets in which a color for a pixel is determined. For instance, the example 400 depicts a second iteration of the stochastic ray tracing technique described above with respect to FIG. 3.

Similar to the above example 300, in this example 400 the rendering module 116 generates binary opacity values 228 for each of the intersections. However, because the binary opacity values 228 are probabilistically determined based on opacity values 222 and stochastic values 226 associated with the respective intersections, in this example the first intersection 306 and the fifth intersection 314 are treated as fully opaque. Because the first intersection 306 is relatively closer to the viewpoint 304 than the fifth intersection 314, the rendering module 116 selects the first intersection 306 as the shading intersection 230.

The rendering module 116 determines a color value 224 associated with the shading intersection 230 and assigns this value as the pixel color 232. The rendering module 116 then applies the pixel color 232 to the pixel 320, which in this example 400 is a red color based on the first Gaussian primitive. In this way, the rendering module 116 renders pixels of transparent primitives without the conventional necessity to sort and process each of the intersections along the ray.

FIG. 5 depicts an additional example 500 of stochastic ray tracing for rendering of digital assets in which a color for a pixel is determined using multiple samples per pixel. In this example 500, the rendering module 116 generates multiple samples per ray (e.g., multiple shading intersections 230 for the ray 302) and determines an average color value for pixel shading.

For instance, in a first iteration 502, the rendering module 116 selects the second intersection 308 as a first shading intersection 506, such as based on binary opacity values 228 and depth values 220 associated with the candidate intersections 218. For instance, the second intersection 308 is the closest opaque intersection in the first iteration 502. The rendering module 116 further ascertains a first color value 508 that is associated with the first shading intersection 506.

In a second iteration 504, the rendering module 116 selects the first intersection 306 as a second shading intersection 510 in accordance with the techniques described herein. For instance, the first intersection 306 is the closest opaque intersection in the second iteration 504. The rendering module 116 further determines a second color value 512 that is associated with the second shading intersection 510. The rendering module 116 then determines an average color value 514 based on the first color value 508 and the second color value 512. The rendering module 116 uses the average color value 514 to determine a pixel color 232 for rendering the pixel 320. As illustrated, the pixel color 232 is an orange color, e.g., a combination of the first color value 508, e.g., yellow, and the second color value 512, e.g., red.

Accordingly, the rendering module 116 is operable to generate and average multiple samples to reduce noise artifacts and improve overall image quality within a single traversal of the acceleration structure 214. For instance, as a number of samples per pixel increases, the averaged color values 514 converge towards an accurate representation of a true color. Further, a computational cost of generating additional samples is relatively small compared to conventional ray-tracing approaches. This balance between quality enhancement and computational efficiency supports production of high-quality renderings while maintaining interactive performance and accessibility for a variety of processing devices.

In at least one example, the shading (e.g., average color value 514) based on multiple samples per pixel is represented as:

$$\hat{L} = \frac{1}{N} {\sum }_{k = 1}^{N} {\hat{L}}_{k}$$

where N is a number of evaluations, e.g., how many times a particular ray 216 is independently traced.

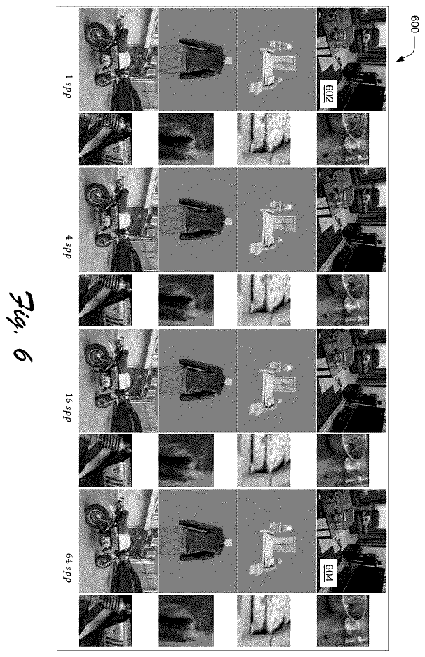

FIG. 6 depicts an example 600 of stochastic ray tracing for rendering of digital assets in which images generated with varying samples per pixel values are depicted. For instance, the example 600 depicts image noise levels at different samples per pixel (“spp”) settings. In this example, each row of images represents renderings at increasing spp values, e.g., from 1 spp to 4 spp to 16 spp to 64 spp.

By way of example, a first image 602 is generated using 1 spp, while a second image 604 is generated using a higher spp value, e.g., 64 spp. The first image 602 and the second image 604 depict a substantially same scene of a living room, however, have different noise levels due to the number of samples used. For instance, as the spp value increases from the first image 602 to the second image 604, the rendering quality improves, and noise levels decrease. As illustrated, the first image 602 exhibits visible noise artifacts, such as graininess or speckling, particularly in areas with complex lighting or fine details. The second image 604, in contrast, demonstrates reduced noise and improved clarity.

Accordingly, the rendering module 116 is configurable to generate images with varying spp settings. In some examples, lower spp settings are preferable, such as for real-time rendering or interactive applications where rapid frame updates are prioritized over image quality. In an additional or alternative example, relatively higher spp settings are used for applications in which image fidelity is prioritized. This flexibility allows the system 200 to adapt to various use cases and hardware capabilities and supports a balance between performance and visual quality based on particular requirements or user preferences.

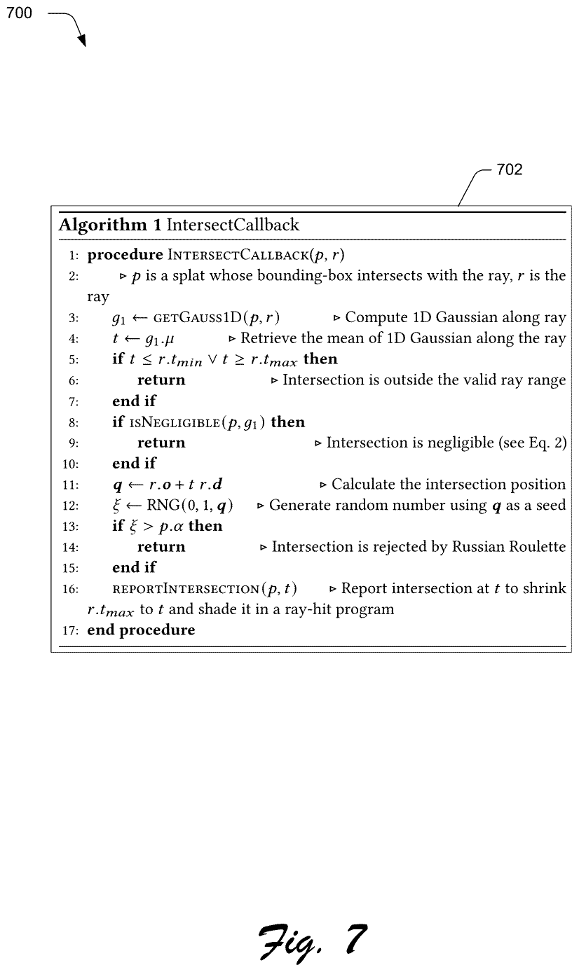

FIG. 7 depicts an example 700 of an algorithm 702 usable to perform aspects of stochastic ray tracing for rendering of digital assets.

In various implementations, the rendering module 116 implements an algorithm 702 to perform one or more aspects of the stochastic ray tracing techniques. For instance, the rendering module 116 leverages the algorithm 702 to identify a shading intersection 230 and shade a pixel based on the shading intersection 230. In this example, the algorithm 702 includes an “IntersectCallback” function that receives a rendering primitive 124, denoted p, which in this example is a Gaussian splat whose bounding box intersects with a ray 216 denoted r at a particular candidate intersection 218.

The rendering module 116 implements the algorithm 702 to first compute a 1D Gaussian along the ray r and further retrieve a mean of the 1D Gaussian along the ray r. In various implementations, the algorithm 702 determines if the particular candidate intersection 218 is outside of a valid ray range, e.g., by comparing t to r.tₘᵢₙ and r.tₘₐₓ. If the particular candidate intersection 218 is outside the range, the rendering module 116 disregards the intersection. The rendering module 116 further leverages the algorithm 702 to determine if the particular candidate intersection 218 is negligible using an “isNegligible” function. If the particular candidate intersection 218 is negligible, the procedure disregards the intersection. In the case that the particular candidate intersection 218 is not negligible, the algorithm 702 is implemented to calculate an intersection position “q” such as based on a ray origin, direction, and a t value.

The rendering module 116 then implements the algorithm 702 to generate a binary opacity value 228 for the particular candidate intersection 218. This includes generation of a stochastic value 226, denoted “ξ”, and comparison of the stochastic value 226 to an opacity value 222 associated with the particular candidate intersection 218. In various implementations, the algorithm 702 utilizes a stateless pseudo-random number generator to generate the stochastic value 226. The stateless pseudo-random number generator produces a random number ξ using q as a seed through an RNG function. This approach allows for efficient generation of random numbers without state maintenance between calls, which is beneficial for parallel processing on graphics hardware, e.g., GPU's.

The algorithm 702 compares the stochastic value ξ to p.α, e.g., the opacity value 222 associated with the particular candidate intersection 218. If ξ is greater than p.α, the intersection is rejected through “Russian Roulette” selection. For instance, the intersection is identified as “transparent” and therefore is excluded from selection. If the intersection is not rejected, the algorithm 702 reports the intersection at t to shrink r.tₘₐₓ to t and shade it in a ray-hit program through a “reportIntersection” function. This step ensures that the closest accepted intersection is processed for shading.

In some implementations, the rendering module 116 adjusts the depth calculation in the algorithm 702 to match one or more rasterization techniques. For instance, the rendering module 116 computes a depth value 220 based on a projected center of 3D Gaussians rather than using the distance from the origin of the ray to the shading position. By aligning the depth calculation with rasterization methods, the algorithm 702 ensures consistency between ray-traced and rasterized renderings of the same scene.

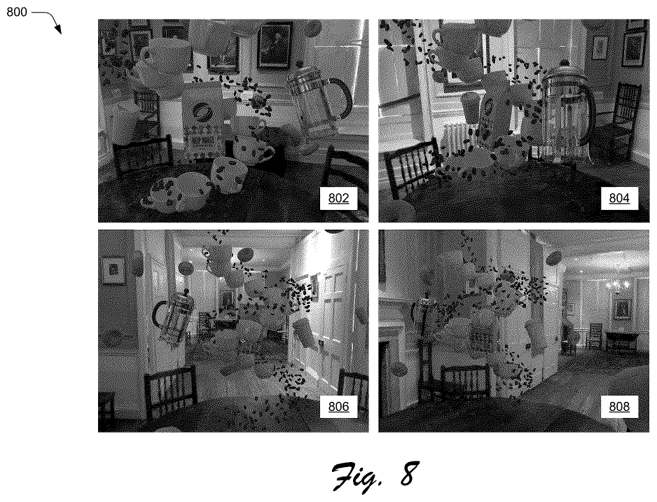

FIG. 8 depicts an example 800 of stochastic ray tracing for rendering of digital assets in which a viewpoint of a scene is changed. The example 800 includes a first view 802, a second view 804, a third view 806, and a fourth view 808 of a scene that includes various rendered assets 118.

In some implementations, the rendering module 116 receives an edit 234 to change a condition of a scene that includes a digital asset defined by rendering primitives. In the illustrated example 800, the edit 234 includes an action to change a point of view of a virtual camera within the scene. For instance, the various digital assets 122 (e.g., cups, French press, coffee beans, etc.) are initially rendered in the first view 802. The rendering module 116 receives an input to change the point of view to the second view 804, then to the third view 806, and finally to the fourth view 808.

Following the techniques described herein, the rendering module 116 is operable to render the various digital assets 122 within the scene in accordance with the changed conditions, e.g., the changed points of view, in a computationally efficient manner while maintaining visual fidelity and realistic lighting effects. In this example, the rendering module 116 generates the edited assets 126 by processing the updated viewpoints, tracing rays from the updated viewpoints, identifying additional candidate intersections 218, and determining updated pixel colors 232 based on updated shading intersections 230, e.g., closest opaque candidate intersections 218 to the updated viewpoints along the rays.

Thus, the techniques described herein are adaptable to changes in viewpoint, object behavior, and scene composition. This approach allows for interactive editing and visualization of complex scenes with multiple transparent primitives, which provides advantages over conventional rendering techniques that do not support real-time updates of scenes containing numerous semi-transparent objects.

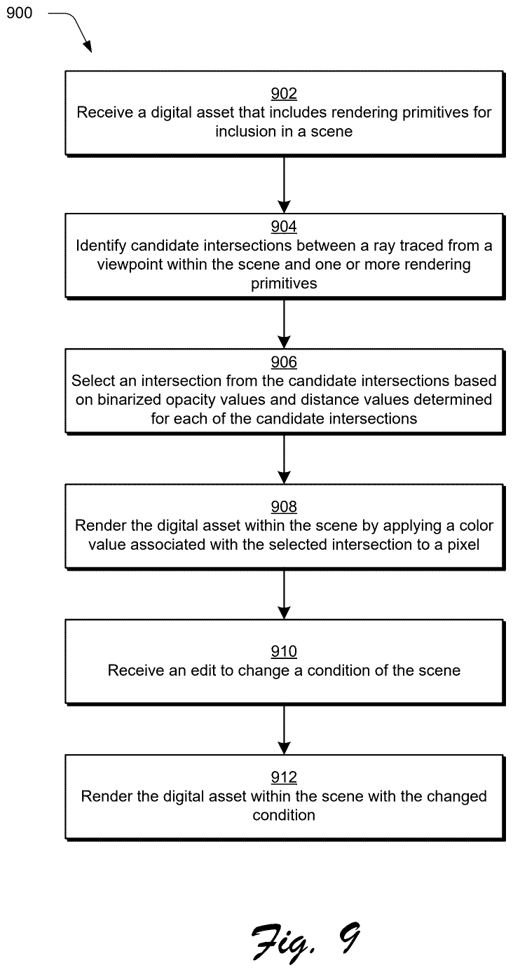

FIG. 9 is a flow diagram depicting an algorithm as a step-by-step procedure 900 in an example implementation that is performable by a processing device to render a digital asset using the stochastic ray tracing techniques described herein.

To begin in this example, a digital asset that includes rendering primitives for inclusion in a scene is received (block 902). The digital asset 122, for instance, includes three-dimensional primitives with varying transparency such as Gaussian splats that define characteristics of objects to be rendered within the scene. In various implementations, the rendering primitives 124 include information about geometry, color, opacity, and other visual properties of the objects.

Candidate intersections between a ray traced from a viewpoint within the scene and one or more of the rendering primitives are then identified (block 904). For instance, the rendering module 116 traverses an acceleration structure 214 associated with the digital asset 122 to determine candidate intersections 218 between the ray 216 and the rendering primitives 124. In some examples, the acceleration structure 214 organizes the rendering primitives 124 in a hierarchical manner such as to enhance efficiency of intersection identification.

An intersection is then selected from the candidate intersections based on binary opacity values and distance values to the viewpoint determined for each of the candidate intersections (block 906). For instance, the rendering module 116 generates binary opacity values 228 for each candidate intersection 218 based on opacity values 222 and stochastic values 226 associated with each candidate intersection 218. The binary opacity value 228 indicates whether a candidate intersection 218 is treated as fully opaque or as fully transparent.

The rendering module 116 then selects a candidate intersection 218, e.g., a shading intersection 230, based on the binary opacity values 228 and depth values 220. In various examples, the shading intersection 230 is selected as a closest intersection (e.g., a candidate intersection 218 having a smallest depth value 220) to the viewpoint that is determined to be opaque, e.g., having a binary opacity value 228 equal to one.

The digital asset is then rendered within the scene by applying a color value associated with the selected intersection to a pixel (block 908). For instance, the rendering module 116 determines the color value 224 based on properties of the rendering primitive 124 associated with the shading intersection 230. The rendering module 116 then applies the color value 224 to the corresponding pixel in the rendered image that includes the rendered asset 118. This process is repeatable to shade each pixel within the image to depict the rendered asset 118 within the scene.

In some examples, an edit is received to change a condition of the scene (block 910). In various examples, the edit 234 includes an adjustment to a viewpoint, modification of a lighting condition, and/or addition or removal of elements from the scene.

The digital asset is then rendered within the scene with the changed condition (block 912). For instance, the rendering module 116 iterates the above-described process (e.g., blocks 904-908) to identify additional candidate intersections 218, select an additional shading intersection 230, and apply updated color values 224 to pixels to realistically depict the edited asset 126 with the updated scene conditions applied.

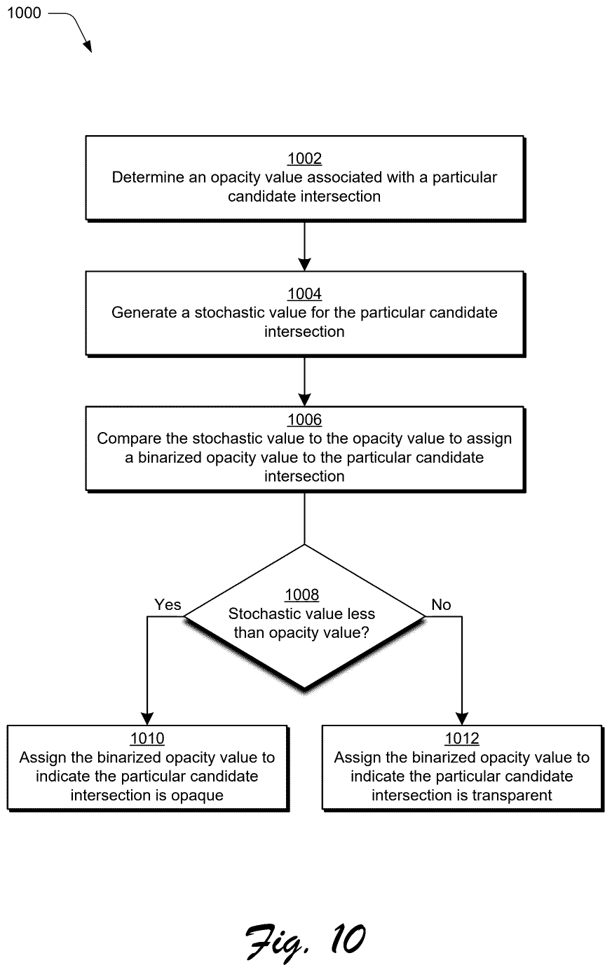

FIG. 10 is a flow diagram depicting an algorithm as a step-by-step procedure 1000 in an example implementation that is performable by a processing device to generate a binarized opacity value. In some examples, one or more of the steps of the procedure 1000 are implementable as substeps of block 906 of FIG. 9.

To begin in this example, an opacity value associated with a particular candidate intersection is determined (block 1002). In various implementations, the rendering module 116 retrieves the opacity value 222 from data associated with the rendering primitive 124 at the particular candidate intersection 218. For instance, if the rendering primitive 124 is a three-dimensional Gaussian splat, the opacity value 222 is derived from properties of the Gaussian function at the particular candidate intersection 218.

A stochastic value is generated for the particular candidate intersection (block 1004). In some examples, the rendering module 116 utilizes a random number generation process to generate the stochastic value 226. In at least one example, the random number generation process includes a pseudo-random number generator seeded with parameters related to the particular candidate intersection 218.

The stochastic value is then compared to the opacity value to assign a binarized opacity value to the particular candidate intersection (block 1006). In various implementations, the rendering module 116 performs this comparison to determine whether the intersection is treated as opaque or transparent in a binary manner. For instance, it is determined whether the stochastic value is less than the opacity value (block 1008).

If the stochastic value is less than the opacity value (e.g., “Yes” at block 1008), the binarized opacity value is assigned to indicate the particular candidate intersection 218 is opaque (block 1010). For example, the rendering module 116 sets the binary opacity value 228 to “1” and/or “true” to represent an opaque intersection. This assignment indicates that the intersection will be considered as a potential shading intersection 230.

Alternatively, if the stochastic value is greater than or equal to the opacity value (e.g., “No” at block 1008), the binary opacity value 228 is assigned to indicate the particular candidate intersection 218 is transparent (block 1012). For instance, the rendering module 116 assigns the binary opacity value 228 to “0” and/or “false” to represent a transparent intersection. This assignment allows the rendering module 116 to filter the particular candidate intersection 218 without considering it for shading.

In some implementations, the rendering module 116 repeats this procedure for each candidate intersection 218 along a ray 216. By stochastically determining opacity in this manner, the rendering module 116 efficiently handles partially transparent primitives without sorting and processing each intersection along each ray. Thus, the techniques described herein reduce computational complexity and memory usage compared to conventional ray tracing approaches.

### Example System and Device

FIG. 11 illustrates an example system generally at 1100 that includes an example computing device 1102 that is representative of one or more computing systems and/or devices that implement the various techniques described herein. This is illustrated through inclusion of the rendering module 116. The computing device 1102 is configurable, for example, as a server of a service provider, a device associated with a client (e.g., a client device), an on-chip system, and/or any other suitable computing device or computing system.

The example computing device 1102 as illustrated includes a processing system 1104, one or more computer-readable media 1106, and one or more I/O interface 1108 that are communicatively coupled, one to another. Although not shown, the computing device 1102 further includes a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 1104 is representative of functionality to perform one or more operations using hardware. Accordingly, the processing system 1104 is illustrated as including hardware element 1110 that is configurable as processors, functional blocks, and so forth. This includes implementation in hardware as an application specific integrated circuit or other logic device formed using one or more semiconductors. The hardware elements 1110 are not limited by the materials from which they are formed or the processing mechanisms employed therein. For example, processors are configurable as semiconductor(s) and/or transistors (e.g., electronic integrated circuits (ICs)). In such a context, processor-executable instructions are electronically-executable instructions.

The computer-readable storage media 1106 is illustrated as including memory/storage 1112. The memory/storage 1112 represents memory/storage capacity associated with one or more computer-readable media. The memory/storage 1112 includes volatile media (such as random access memory (RAM)) and/or nonvolatile media (such as read only memory (ROM), Flash memory, optical disks, magnetic disks, and so forth). The memory/storage 1112 includes fixed media (e.g., RAM, ROM, a fixed hard drive, and so on) as well as removable media (e.g., Flash memory, a removable hard drive, an optical disc, and so forth). The computer-readable media 1106 is configurable in a variety of other ways as further described below.

Input/output interface(s) 1108 are representative of functionality to allow a user to enter commands and information to computing device 1102, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., employing visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 1102 is configurable in a variety of ways as further described below to support user interaction.

Various techniques are described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques are configurable on a variety of commercial computing platforms having a variety of processors.

An implementation of the described modules and techniques is stored on or transmitted across some form of computer-readable media. The computer-readable media includes a variety of media that is accessed by the computing device 1102. By way of example, and not limitation, computer-readable media includes “computer-readable storage media” and “computer-readable signal media.”

“Computer-readable storage media” refers to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable, and non-removable media and/or storage devices implemented in a method or technology suitable for storage of information such as computer readable instructions, data structures, program modules, logic elements/circuits, or other data. Examples of computer-readable storage media include but are not limited to RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and are accessible by a computer.

“Computer-readable signal media” refers to a signal-bearing medium that is configured to transmit instructions to the hardware of the computing device 1102, such as via a network. Signal media typically embodies computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 1110 and computer-readable media 1106 are representative of modules, programmable device logic and/or fixed device logic implemented in a hardware form that are employed in some embodiments to implement at least some aspects of the techniques described herein, such as to perform one or more instructions. Hardware includes components of an integrated circuit or on-chip system, an application-specific integrated circuit (ASIC), a field-programmable gate array (FPGA), a complex programmable logic device (CPLD), and other implementations in silicon or other hardware. In this context, hardware operates as a processing device that performs program tasks defined by instructions and/or logic embodied by the hardware as well as a hardware utilized to store instructions for execution, e.g., the computer-readable storage media described previously.

Combinations of the foregoing are also employed to implement various techniques described herein. Accordingly, software, hardware, or executable modules are implemented as one or more instructions and/or logic embodied on some form of computer-readable storage media and/or by one or more hardware elements 1110. The computing device 1102 is configured to implement particular instructions and/or functions corresponding to the software and/or hardware modules. Accordingly, implementation of a module that is executable by the computing device 1102 as software is achieved at least partially in hardware, e.g., through use of computer-readable storage media and/or hardware elements 1110 of the processing system 1104. The instructions and/or functions are executable/operable by one or more articles of manufacture (for example, one or more computing devices 1102 and/or processing systems 1104) to implement techniques, modules, and examples described herein.

The techniques described herein are supported by various configurations of the computing device 1102 and are not limited to the specific examples of the techniques described herein. This functionality is also implementable all or in part through use of a distributed system, such as over a “cloud” 1114 via a platform 1116 as described below.

The cloud 1114 includes and/or is representative of a platform 1116 for resources 1118. The platform 1116 abstracts underlying functionality of hardware (e.g., servers) and software resources of the cloud 1114. The resources 1118 include applications and/or data that can be utilized while computer processing is executed on servers that are remote from the computing device 1102. Resources 1118 can also include services provided over the Internet and/or through a subscriber network, such as a cellular or Wi-Fi network.

The platform 1116 abstracts resources and functions to connect the computing device 1102 with other computing devices. The platform 1116 also serves to abstract scaling of resources to provide a corresponding level of scale to encountered demand for the resources 1118 that are implemented via the platform 1116. Accordingly, in an interconnected device embodiment, implementation of functionality described herein is distributable throughout the system 1100. For example, the functionality is implementable in part on the computing device 1102 as well as via the platform 1116 that abstracts the functionality of the cloud 1114.

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. A method comprising:
receiving, by a processing device, a digital asset that includes three-dimensional primitives to be included in a scene;
identifying, by the processing device, candidate intersections between a ray traced from a viewpoint within the scene and one or more of the three-dimensional primitives;
selecting, by the processing device, an intersection from the candidate intersections based on binarized opacity values and distance values to the viewpoint determined for each of the candidate intersections; and
rendering, by the processing device, the digital asset within the scene by applying a color value associated with the selected intersection to a pixel.

2. The method as described in claim 1, wherein the binarized opacity values are probabilistically binarized based on opacity values associated with the candidate intersections to indicate whether the candidate intersections are opaque or transparent.

3. The method as described in claim 1, wherein the three-dimensional primitives include transparent three-dimensional Gaussian splats, and each candidate intersection is associated with a depth value, a color value, and an opacity value based on the three-dimensional Gaussian splats.

4. The method as described in claim 1, further comprising generating a binarized opacity value for a particular candidate intersection by:
determining an opacity value associated with the particular candidate intersection;
generating a stochastic value for the particular candidate intersection using a random number generation process; and
comparing the stochastic value to the opacity value to assign the binarized opacity value to the particular candidate intersection.

5. The method as described in claim 4, wherein the stochastic value is less than the opacity value and the binarized opacity value indicates the particular candidate intersection is opaque.

6. The method as described in claim 4, wherein the stochastic value is greater than or equal to the opacity value and the binarized opacity value indicates the particular candidate intersection is transparent.

7. The method as described in claim 1, wherein the selected intersection has a binarized opacity value that indicates the selected intersection is opaque and a lowest distance value relative to other distance values of the candidate intersections.

8. The method as described in claim 1, wherein identifying the candidate intersections includes traversing an acceleration structure associated with the digital asset.

9. The method as described in claim 1, further comprising selecting an additional intersection from the candidate intersections and wherein the color value applied to the pixel is based on a first color value associated with the selected intersection and a second color value associated with the additional intersection.

10. A system comprising:
a memory component; and
a processing device coupled to the memory component, the processing device to perform operations including:
receiving an input to depict a digital asset that includes rendering primitives within a scene;
determining color values to apply to pixels to visually represent the digital asset within the scene by:
identifying candidate intersections between rays traced from a viewpoint within the scene and one or more of the rendering primitives; and
selecting, for each of the rays, an intersection from the candidate intersections based on binarized opacity values and distance values to the viewpoint for each of the candidate intersections; and
rendering the digital asset within the scene by applying color values associated with the selected intersections to the pixels.

11. The system as described in claim 10, the operations further including generating a binarized opacity value for a particular candidate intersection by:
determining a non-binarized opacity value associated with the particular candidate intersection;
generating a stochastic value for the particular candidate intersection using a random number generation process; and
comparing the stochastic value to the non-binarized opacity value to assign the binarized opacity value to the particular candidate intersection.

12. The system as described in claim 11, wherein a stochastic value that is less than the non-binarized opacity value indicates the particular candidate intersection is opaque and a stochastic value that is greater than or equal to the non-binarized opacity value indicates the particular candidate intersection is transparent.

13. The system as described in claim 10, wherein the selected intersection for a particular ray has a binarized opacity value that indicates the selected intersection is opaque and the selected intersection has a lowest distance value relative to other distance values of the candidate intersections for the particular ray.

14. The system as described in claim 10, wherein determining the color values includes selecting two or more intersections from the candidate intersections for each of the rays and computing an average color value between color values associated with the two or more selected intersections.

15. The system as described in claim 10, the operations further including receiving an edit to change a condition of the scene and rendering the digital asset within the scene with the changed condition by selecting one or more additional intersections and applying color values associated with the one or more additional intersections to the pixels.

16. The system as described in claim 10, wherein the rendering primitives include three-dimensional Gaussian splats, and each candidate intersection is associated with a depth value, a color value, and an opacity value based on the three-dimensional Gaussian splats.

17. A non-transitory computer-readable storage medium storing executable instructions, which when executed by a processing device, cause the processing device to perform operations comprising:
receiving an edit to change a condition of scene that includes a digital asset defined by rendering primitives;
identifying candidate intersections between a ray traced from a viewpoint within the scene with the changed condition and one or more of the rendering primitives;
selecting an intersection from the candidate intersections based on binarized opacity values and distance values to the viewpoint associated with each of the candidate intersections; and
rendering the digital asset within the scene with the changed condition by applying a color value associated with the selected intersection to a pixel.

18. The non-transitory computer-readable storage medium as described in claim 17, wherein the changed condition includes one or more of an adjusted viewpoint, modified lighting condition, or addition or removal of an additional digital asset from the scene.

19. The non-transitory computer-readable storage medium as described in claim 17, wherein the rendering primitives include three-dimensional Gaussian splats, and each candidate intersection is associated with a depth value, a color value, and an opacity value based on the three-dimensional Gaussian splats.

20. The non-transitory computer-readable storage medium as described in claim 17, the operations further including generating a binarized opacity value for a particular candidate intersection by:
determining an opacity value associated with the particular candidate intersection;
generating a stochastic value for the particular candidate intersection using a random number generation process; and
comparing the stochastic value to the opacity value to assign the binarized opacity value to the particular candidate intersection.
